(19) United States
(12) Patent Application Publication
(10) Pub. No.: US 2015/0217779 A1
(43) Pub. Date: Aug. 6, 2015

(54) METHOD FOR CONTROLLING THE OPERATION OF A HYBRID VEHICLE AND HYBRID VEHICLE HAVING A CONTROL OPERABLE ACCORDING TO SAID METHOD

(71) Applicant: Robert Bosch GmbH, Stuttgart (DE)

(72) Inventors: Kaspar Schmoll Genannt Eisenwerth, Vaihingen-Horrheim (DE); Werner Weber, Vaihingen (DE)

(21) Appl. No.: 14/419,501

(22) PCT Filed: Jul. 4, 2013
(86) PCT No.: PCT/EP2013/064159

§ 371 Date: Feb. 4, 2015

(30) Foreign Application Priority Data
Aug. 10, 2012 (DE) 10 2012 214 252.5

(51) Int. Cl. B60W 50/08; B60W 10/26; B60W 10/06; B60W 10/08; G01C 21/34; B60W 20/00

(52) U.S. Cl. CPC B60W 50/082; G01C 21/3469; B60W 20/106; B60W 10/06; B60W 10/08; B60W 10/26; Y10S 903/93

(57) ABSTRACT

The invention relates to a method for controlling the operation of a hybrid vehicle and to a hybrid vehicle using said method, which vehicle can be driven by an internal combustion engine and/or an electrical drive which can be supplied via a reserve of stored electrical energy, wherein the vehicle comprises a drive control having a user interface and wherein the method comprises a user determining by means of the user interface that the vehicle be driven primarily only by the electrical drive at a specific point in time and/or for a specific length of time or route.

### BACKGROUND OF THE INVENTION

The present invention relates to a method for controlling the operation of a hybrid vehicle and to a hybrid vehicle having a control operable according to said method.

It is known from the prior art that hybrid vehicles which are currently commercially available and so-called plug-in hybrid vehicles can only be slightly influenced in the road handling thereof, i.e. in the manner in which said vehicles are operated, by the driver or, respectively, user himself. In conventional hybrid vehicles, a drive control situated on board the vehicle essentially takes over the strategic decisions itself, i.e. as a function of the current driving situation with respect to torque coordination and battery charge. As a rule, the driver can only select a desired torque (via the accelerator pedal position) and/or a driving mode. The driving mode is normally divided into the operating modes “Eco”, “normal” and “Sport”. When changing the operating mode, the drive results according to a corresponding family of (engine) characteristics which are preset or programmed into the control, i.e. an operating strategy on which the driver cannot exercise any influence except for preselecting the corresponding operating mode.

The respective family of characteristics (respectively the operating mode selected in each case) specifies, for example, how large a proportion of the total drive for the vehicle is to be supplied in each case by the electrical drive or by the internal combustion engine drive. The driver can in fact, for example, select to use up the supply of electrical energy in a corresponding operating mode (“depleting”) up to a lower threshold value, wherein the system is then automatically, i.e. due to the selected operating mode, switched over into a charge maintenance operating mode (“sustaining”) upon reaching said lower threshold value. A direct exertion of influence by the driver on the proportion of the total drive supplied by the electrical drive (e.g. 100%) and namely with regard to length of time and/or the route to be driven is not currently possible.

### SUMMARY OF THE INVENTION

The invention relates with regard to a first aspect to a method for controlling the operation of a hybrid vehicle which can be driven by an internal combustion engine and/or an electrical drive which can be supplied via a reserve of stored electrical energy, wherein the vehicle comprises a drive control having a user interface and wherein the method comprises a user determining by means of the user interface that the vehicle be driven primarily only by the electrical drive at a specific point in time and/or for a specific length of time.

With regard to a second aspect, the invention relates to a hybrid vehicle having a drive control which executes the method according to the first aspect.

The advantage of the system proposed results from the fact that the driver or user can exert direct influence via the user interface as to when and/or for how long and/or for which route to be travelled the vehicle is to be purely electrically operated. This has the advantage that the driver can himself/herself decide when he/she would like the vehicle to be operated with as low emissions as possible and/or with as little noise as possible, for example when driving through a town and/or an inner city area requiring reduced emissions.

The user preferably determines by means of the user interface that the electrical drive is employed until the electrical energy available to the electrical drive is depleted. In so doing, the user can select a purely electrical drive if he/she is operating the vehicle in, e.g., a low emission zone at least until the reserve of electrical energy has been depleted.

It is furthermore preferred that the user determines via the interface one or a plurality of geographical areas and/or one or a plurality of routes to be travelled in which the vehicle is only to be operated with the electrical drive. An advantage here is that a purely electrical drive is or will be possible for the selected geographical area or the selected route to be travelled. As a result, the vehicle will be driven with the internal combustion engine and during that time, if necessary and desired by the driver, an energy storage for the electric drive will be recharged up until the geographical area or locality has been reached or the user inputs via the interface a further or different stipulation with regard to the operation of the electrical drive.

As a result, the user can also advantageously determine by means of the interface the length of the route to be travelled in order to completely recharge the reserve of stored energy. This is advantageous if the user knows the length of the route to be travelled, so that he/she can then, i.e. after travelling the route, purely electrically operate the vehicle with a completely charged energy storage.

In addition, it is preferred that the user is informed via the interface if the reserve of electrical energy is expected not to be sufficient for an electrical drive of the vehicle for the planned route which was determined by the user via the interface. This has the advantage that the user receives information about the energy reserve that is available and, upon receiving information about the energy reserve not being expected to be sufficient for a determined electrical drive, can accordingly determine whether the reserve of the energy storage is to be recharged with electrical energy via a charging station or by means of the internal combustion engine coupled to the generator, e.g. when driving or when the vehicle is at rest.

The electrical energy storage of the hybrid vehicle preferably comprises one or a plurality of batteries, e.g. lithium-ion batteries.

### BRIEF DESCRIPTION OF THE DRAWINGS

The invention is explained below with the aid of embodiments in combination with the drawings, wherein:

FIG. 1 shows a diagram on the basis of which the method is explained according to one embodiment of the invention; and

FIG. 2 shows a diagram on the basis of which the method is explained according to a further embodiment.

### DETAILED DESCRIPTION

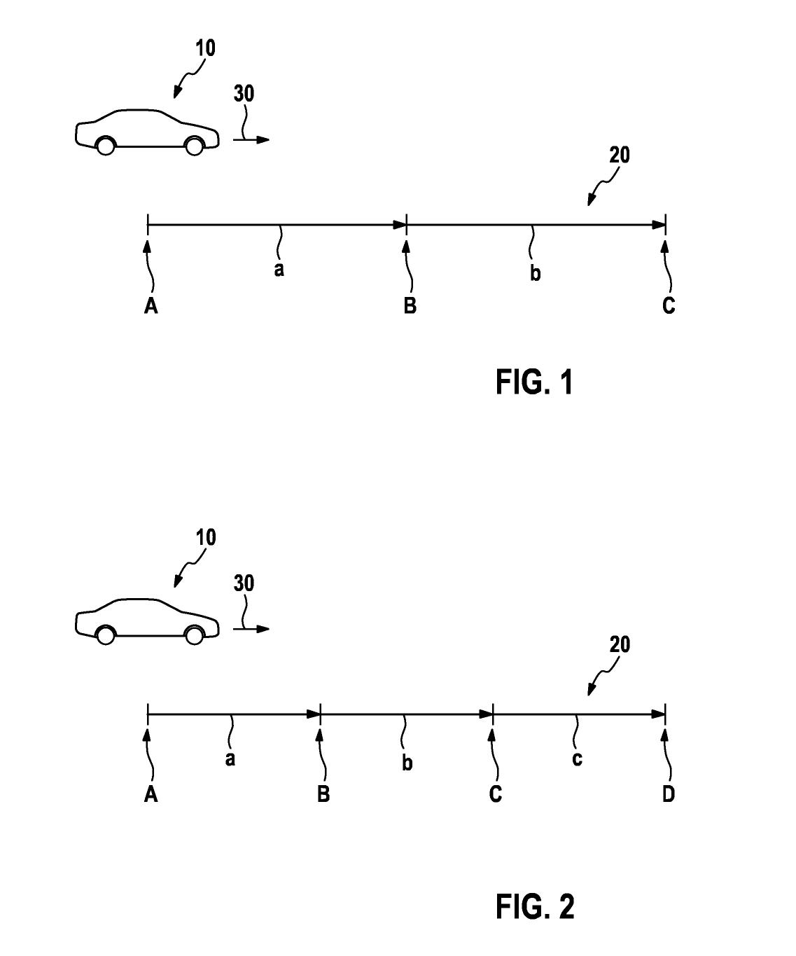

FIG. 1 shows a diagram for illustrating an embodiment of the invention, wherein a hybrid vehicle 10 which comprises a user interface (which is not depicted here for reasons of clarity) for the direct exertion of influence on the operating strategy of the hybrid vehicle 10 by the user or, respectively, driver. The hybrid vehicle 10 comprises, as is known from the prior art, an internal combustion engine drive and an electrical drive as well as an energy storage for the electrical drive, which are however not separately depicted in the figures. Batteries, such as, e.g., lithium-ion batteries, come into consideration as energy storages.

A time or, respectively, route bar, which is only for explanatory purposes, is depicted below the vehicle 10 in FIG. 1, a sort of one dimensional coordinate system in which the vehicle initially is to be located at point A. It does not matter here whether the vehicle 10 is in motion (indicated by an arrow 30) or at rest.

By means of the user interface disposed in the vehicle 10, the driver now has the option of determining that a route or time duration a is to be travelled strictly with electrical drive and namely until he/she has arrived at point B. The section a can relate, for example, to a low-emission zone or to an area in which the driver wants to drive with as little noise as possible. The driver can also determine by means of the interface that the vehicle 10 is to be operated strictly with electrical drive only in designated low-emission zones.

The route from point B to point C, i.e. the section b, is driven with the vehicle employing the use of the internal combustion engine or in a hybrid manner, wherein the energy storage is also recharged.

FIG. 2 shows a diagram for illustrating a further embodiment of the invention having a situation similar to that depicted in FIG. 1; however, with the difference that a further section c and a point D are plotted on the time/route bar 20.

The vehicle 10 is operated by means of the internal combustion engine or in a hybrid manner (i.e. by means of the internal combustion engine as well as electrically) from point A to point B, i.e. while covering the section a, which can represent a time duration or a route to be travelled. The point B can be specified by the driver as the point where the energy storage is completely charged. The driver knows, for example, when daily commuting to his/her workplace, which distance or length of time is required to reach a low-emission zone or a city and can input this information via the interface into the drive control.

Starting at point B, the driver can then operate the vehicle 10 purely electrically for the section b because he/she is then, for example, located in a low-emission zone or in any other geographical area where the driver would like to operate the vehicle 10 only in a purely electrical manner, for example within the territorial limits of a town or village during long-distance trips.

Starting at point C, the situation can arise that the energy storage is depleted and the driver receives information to this effect via the interface. He/she has then again the option, as already explained with regard to FIG. 1, of recharging the energy storage by means of a charging station or via the internal combustion engine. In the event that the driver would like to have a battery which is charged as fully as possible at the end of the trip, the driver can also alternatively travel across section c while operating the internal combustion engine until the energy storage is recharged as best as possible at point D which the driver can specify as a point in time or as a location.

It is however also conceivable that the driver would like to travel across section c strictly using the electrical drive, for example to ensure a silent running to his/her residential area in his/her home town. It should also be emphasized in this instance that the driver has the option of determining via the interface the route which is still to be travelled (for example section c) or the length of time during which a pure electrical drive is to occur.

It is also further conceivable to couple the control system to a navigation device, wherein the navigation device can simultaneously serve as a user interface for inputs by the driver. This results from the fact that the navigation device is already designed for an input and calculation of routes desired to be travelled. The control system then “knows” via the navigation system when a certain, specified route has been covered or a length of time has elapsed or, respectively when certain, specified geographical locations have been reached. It is also conceivable to determine, i.e. program in, certain geographical areas (e.g. low-emission zones), where, upon reaching said areas, the drive control switches on its own volition to a purely electrical drive. It should however again be emphasized that the basic principle of the invention is that the driver or, respectively, user can himself/herself by means of the interface exert a direct influence on the type of drive (only electrical, only using the internal combustion engine or any combination thereof) as well as on the length of time and/or the point in time for which or at which the specific type of drive is to be employed. Other suitable types of interfaces are also conceivable, for example a radio situated on board the vehicle or other input devices that are already standardly installed in today's vehicles.

In closing, it should be noted that the dimensions depicted in FIGS. 1 and 2 are not true to scale.

1. A method for controlling the operation of a hybrid vehicle (10) which can be driven by an internal combustion engine and/or an electrical drive which can be supplied via a reserve of stored electrical energy, wherein the vehicle (10) comprises a drive control having a user interface and wherein the method comprises a user determining by using a user interface that the vehicle (10) be driven primarily only by the electrical drive at a specific point in time (A, B, C) and/or for a specific length of time or route (a, b, c).

2. The method according to claim 1, wherein the user determines by using the user interface that the electrical drive takes place up until the electrical energy available for said electrical drive is depleted.

3. The method according to claim 1, wherein the user determines by using the interface one or a plurality of geographical areas and/or one or a plurality of routes to be travelled, in which the vehicle (10) is only driven by the electrical drive.

4. The method according to claim 1, wherein the vehicle (10) is driven by the internal combustion engine and meanwhile an energy storage for the electrical drive is charged with electrical energy up until the user inputs via the interface a determination with regard to the operation of the electrical drive.

5. The method according to claim 4, wherein the user determines by using the interface which route has to be covered in order for the reserve of stored energy to be recharged to the greatest possible extent or completely.

6. The method according to claim 4, wherein the user determines by using the interface a geographical location that has to be reached by the vehicle (10) in order for the reserve of stored energy to be recharged to the greatest possible extent or sufficiently for the next specified length of time or route (a, b, c).

7. The method according to claim 1, wherein the user is informed via the interface whether the reserve of electrical energy is not expected to be sufficient for an electrical drive determined by the user via the interface.

8. The method according to claim 7, wherein the user, upon receiving information that the electrical energy reserve is not expected to be sufficient for the specified electrical drive, can optionally determine whether the reserve of the electrical storage is to be recharged with electrical energy via a charging station or via the internal combustion engine that is coupled to a generator.

9. The method according to claim 1, wherein the drive control is coupled to a navigation device which comprises the interface.

10. A hybrid vehicle having a drive control which executes the method according to claim 1.

11. The hybrid vehicle according to claim 10, wherein the user determines by using the user interface that the electrical drive takes place up until the electrical energy available for said electrical drive is depleted.

12. The hybrid vehicle according to claim 10, wherein the user determines by using the interface one or a plurality of geographical areas and/or one or a plurality of routes to be travelled, in which the vehicle (10) is only driven by the electrical drive.

13. The hybrid vehicle according to claim 10, wherein the vehicle (10) is driven by the internal combustion engine and meanwhile an energy storage for the electrical drive is charged with electrical energy up until the user inputs via the interface a determination with regard to the operation of the electrical drive.

14. The hybrid vehicle according to claim 13, wherein the user determines by using the interface which route has to be covered in order for the reserve of stored energy to be recharged to the greatest possible extent or completely.

15. The hybrid vehicle according to claim 13, wherein the user determines by using the interface a geographical location that has to be reached by the vehicle (10) in order for the reserve of stored energy to be recharged to the greatest possible extent or sufficiently for the next specified length of time or route (a, b, c).

16. The hybrid vehicle according to claim 10, wherein the user is informed via the interface whether the reserve of electrical energy is not expected to be sufficient for an electrical drive determined by the user via the interface.

17. The hybrid vehicle according to claim 16, wherein the user, upon receiving information that the electrical energy reserve is not expected to be sufficient for the specified electrical drive, can optionally determine whether the reserve of the electrical storage is to be recharged with electrical energy via a charging station or via the internal combustion engine that is coupled to a generator.

18. The hybrid vehicle according to claim 10, wherein the drive control is coupled to a navigation device which comprises the interface.
